(19) United States
(12) Patent Application Publication
(10) Pub. No.: US 2022/0017131 A1
(43) Pub. Date: Jan. 20, 2022

(54) LAWN ROLLER-WHEELBARROW

(71) Applicant: Troy Hopkins, Huntsville, AL (US)

(72) Inventor: Troy Hopkins, Huntsville, AL (US)

(21) Appl. No.: 16/928,374

(22) Filed: Jul. 14, 2020

(51) Int. Cl. B62B 1/20; A01G 20/35; A01B 29/02

(52) U.S. Cl. CPC B62B 1/20; B62B 2206/006; A01B 29/02; A01G 20/35

(57) ABSTRACT

Implementations of a lawn roller-wheelbarrow are provided. The lawn roller-wheelbarrow comprises a roller-wheel that can be used to even out a lawn surface and a tray adapted to carry a load. Through the use of a wheel adapted to act as a lawn roller, the tray can be used to transport a load without leaving a track, or potentially creating a rut, in the lawn surface. The preferred implementation of the lawn roller-wheelbarrow comprises: a frame that includes a pair of handles, a tray mounted on the frame that is adapted for carrying a load, and a roller-wheel rotatably mounted to the frame. The roller-wheel has the general shape of a cylinder and a length L that is greater than its width W (or diameter).

### TECHNICAL FIELD

This disclosure relates to implementations of a lawn roller-wheelbarrow that can be used to even out a lawn surface while also carrying a load.

### BACKGROUND

A lawn roller is an agricultural tool routinely used to establish and/or maintain a lawn. A lawn roller may be useful when laying down sod, planting grass seed, or smoothing down molehills and ruts. Typically, a lawn roller is a cylindrical roller with added weight, often water or sand, used to flatten ground.

A wheelbarrow is designed to distribute the weight of its load between one or more wheels and the operator. Typically, a wheelbarrow includes a tray or bin, at least one wheel, and a frame having a pair of legs and a pair handles attached thereto. A wheelbarrow is moved by lifting its handles to raise the legs off the ground, balancing the wheelbarrow on its wheel(s), and then walking while pushing or pulling the handles. A wheelbarrow is typically unloaded (i.e., dumped) by lifting the handles to tip the tray or bin into a vertical position where the load slides or pours out the sloped front end of the tray.

Wheelbarrows are often used to move loads across lawns and other surfaces. Wheelbarrows are also useful because they can easily dump their load. However, as the weight of the load increases, the narrow wheels found on prior art wheelbarrows can leave a track, or even a rut, in the surface of the lawn. A narrow wheel having a diameter (or width) that is greater than its length.

Accordingly, it can be seen that needs exist for the lawn roller-wheelbarrow disclosed herein. It is to the provision of a lawn roller-wheelbarrow configured to address these needs, and others, that the present invention is primarily directed.

### SUMMARY OF THE INVENTION

Implementations of a lawn roller-wheelbarrow are provided. The lawn roller-wheelbarrow comprises a roller-wheel that can be used to even out a lawn surface and a tray adapted to carry a load. Through the use of a wheel adapted to act as a lawn roller, the tray can be used to transport a load without leaving a track, or potentially creating a rut, in the lawn surface.

The preferred implementation of the lawn roller-wheelbarrow comprises: a frame that includes a pair of handles, a tray mounted on the frame that is adapted for carrying a load, and a roller-wheel rotatably mounted to the frame. The roller-wheel has the general shape of a cylinder and a length L that is greater than its width W.

The surface area of the cylindrically shaped roller-wheel, as compared to the narrow wheel(s) used by conventional wheelbarrows, distributes the weight of any load carried in the tray over a larger area. In this way, the lawn roller-wheelbarrow can be used to transport a load without leaving a track, or potentially creating a rut, in the lawn surface.

### BRIEF DESCRIPTION OF THE DRAWINGS

FIGS. 1 and 2 illustrate isometric views of an exemplary implementation of a lawn roller-wheelbarrow according to the principles of the present disclosure.

FIG. 3 illustrates a front view of the lawn roller-wheelbarrow shown in FIGS. 1 and 2.

FIG. 4 illustrates a left side view of the lawn roller-wheelbarrow shown in FIGS. 1 and 2.

FIG. 5 illustrates a rear view of the lawn roller-wheelbarrow shown in FIGS. 1 and 2.

FIG. 6 illustrates a top view of the lawn roller-wheelbarrow shown in FIGS. 1 and 2.

FIG. 7 illustrates a bottom view of the lawn roller-wheelbarrow shown in FIGS. 1 and 2.

FIG. 8 illustrates an exploded view of the lawn roller-wheelbarrow shown in FIGS. 1 and 2.

Like reference numerals refer to corresponding parts throughout the several views of the drawings.

### DETAILED DESCRIPTION

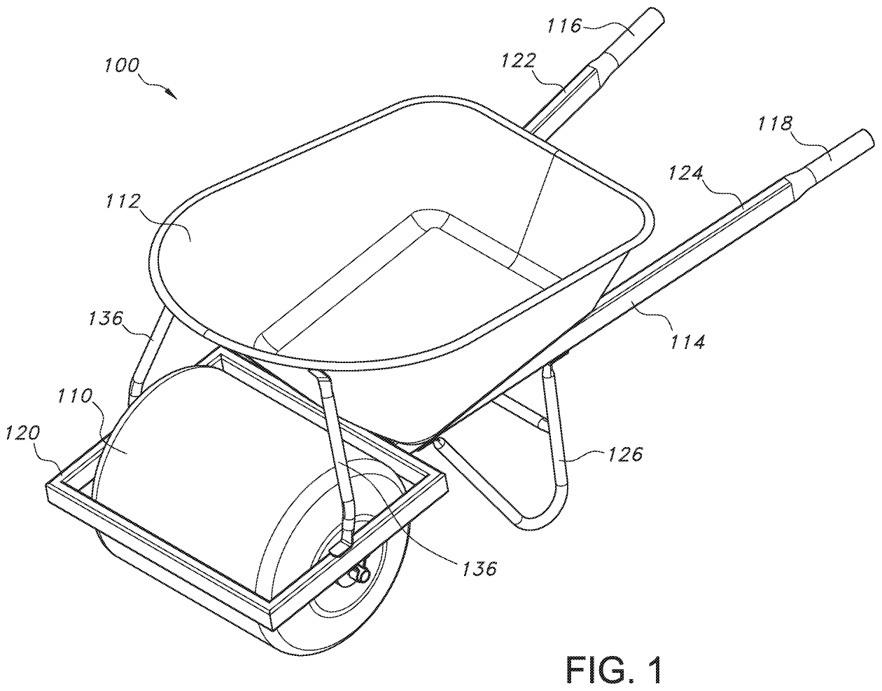

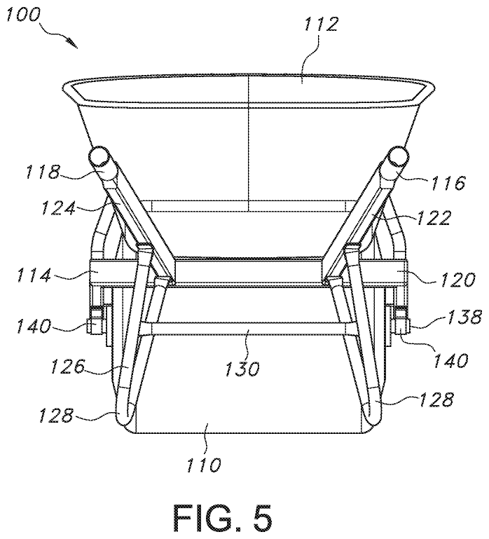

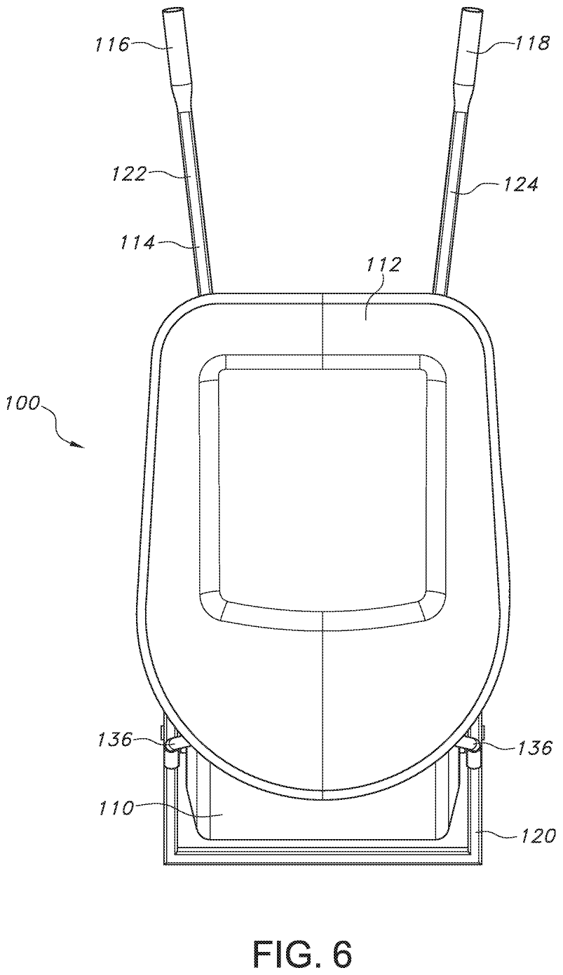

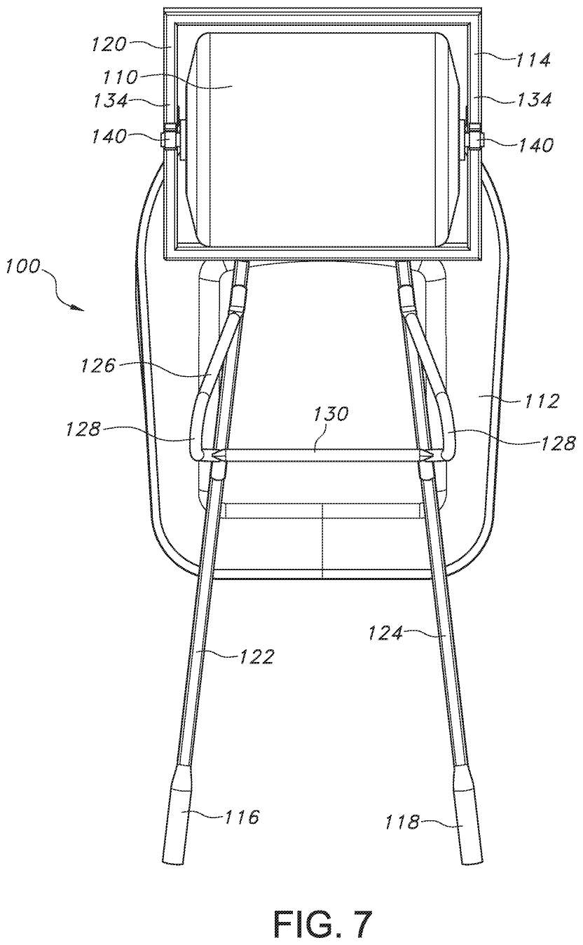

FIGS. 1-8 illustrate an example a lawn roller-wheelbarrow 100 according to the principles of the present disclosure. The lawn roller-wheelbarrow 100 comprises a roller-wheel 110 that can be used to even out a lawn surface and a tray 112 adapted to carry a load. Through the use of a wheel 110 adapted to act as a lawn roller, the tray 112 can be used to transport a load without leaving a track, or creating a rut, in the lawn surface.

As shown in FIGS. 1-8, the preferred implementation of the lawn roller-wheelbarrow 100 comprises: a frame 114 that includes a pair of handles (116, 118), a tray 112 mounted on the frame 114 that is adapted for carrying a load, and a roller-wheel 110 rotatably mounted to the frame 114. The roller-wheel 110 has the general shape of a cylinder and a length L that is greater than its width W.

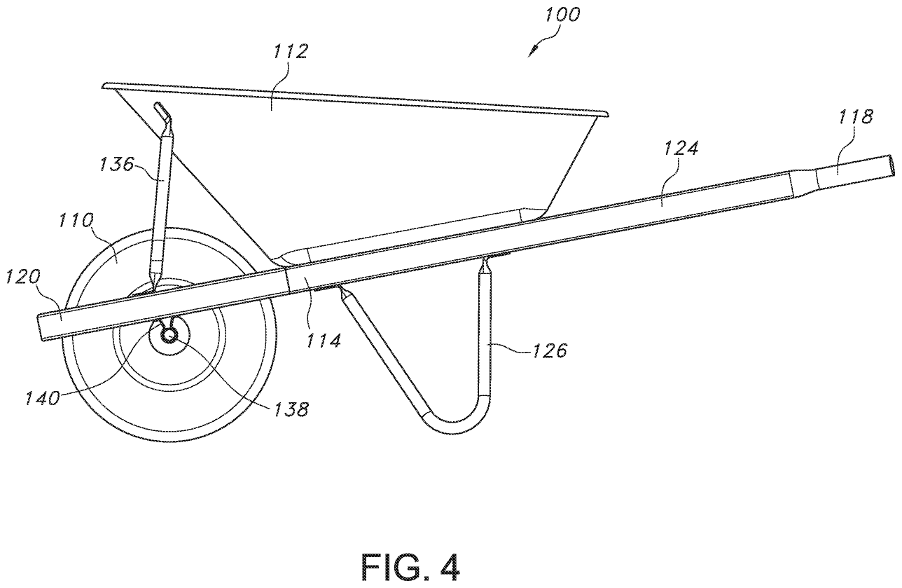

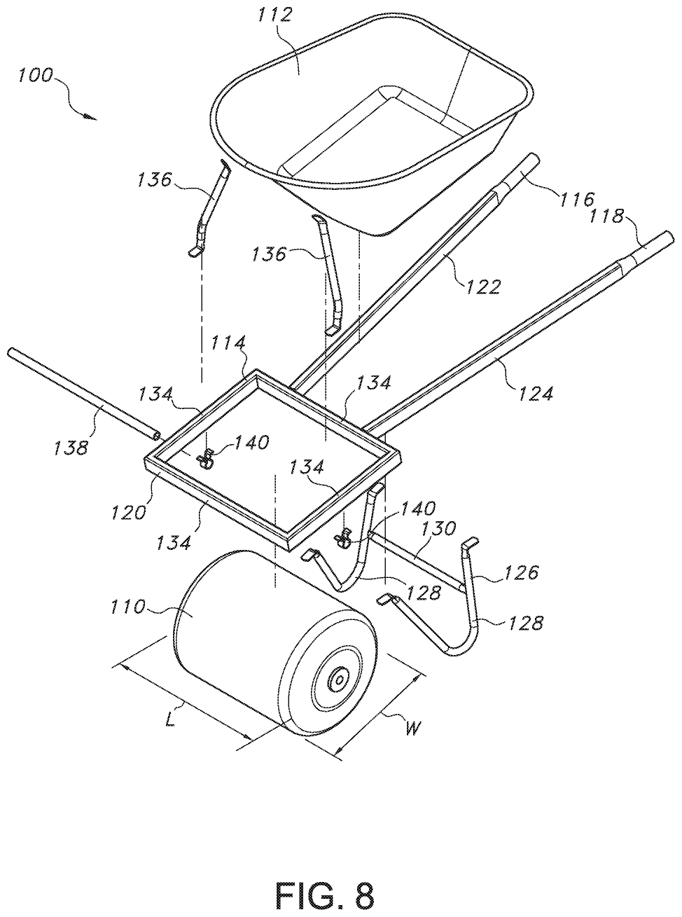

As shown best in FIG. 8, the frame 114 includes a roller-wheel support structure 120 and a pair of arm members 122, 124. Each arm member 122, 124 includes a handle 116, 118 on its distal end. The roller-wheel support structure 120 of the frame 114 is configured so that the roller-wheel 110 can be rotatably mounted within an opening 132 defined thereby. The preferred implementation of the rectangle-shaped opening 132 is defined by an arrangement of four frame members 134 that are secured together. The arm members 122, 124 extend rearwardly from the roller-wheel support structure 120 and underneath the tray 112, thereby providing support for the tray 112 resting thereon (see, e.g., FIG. 4). While the preferred implementation of the roller-wheel support structure 120 and the arm members 122, 124 are made of wood, it is contemplated that, in some implementations, one or more of these structures could be fabricated of another suitable material (e.g., a metal alloy or plastic).

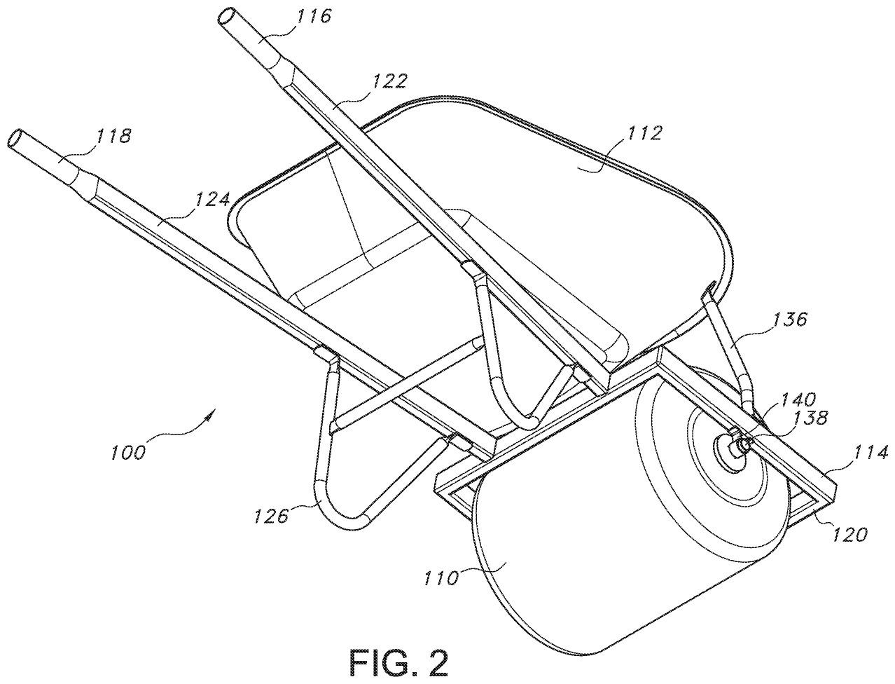

As shown best in FIGS. 2, 4, and 8, a stand 126 used to keep the lawn roller-wheelbarrow 100 balanced in the horizontal position while it rests on the ground is secured to the frame 114. The stand 126 has two leg members 128 connected by a horizontal leg brace member 130. One of the leg members 128 is secured to the underside of each frame member 122, 124. While the preferred implementation of the stand 126 is made of aluminum, it is contemplated that, in some implementations, the stand 126 could be fabricated of another metal or other suitable material (e.g., plastic).

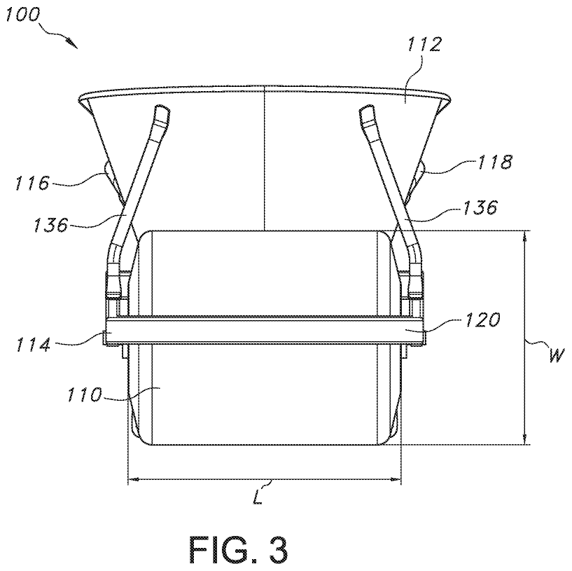

The roller-wheel 110 is adapted to even out a lawn surface as it passes thereover and to prevent, or at least minimize, the formation of ruts in the lawn surface. In particular, as shown best in FIGS. 3 and 8, the preferred implementation of the roller-wheel 110 has a generally cylindrical shape and a length L that is greater than its width W (or diameter). The large surface area of the drum shaped roller-wheel 110, as compared to the narrow wheel(s) used by conventional wheelbarrows, distributes the weight of any load carried in the tray 112 over a larger area. In this way, the lawn roller-wheelbarrow 100 can be used to transport a load without leaving a track, or potentially creating a rut, in the lawn surface.

In general, the preferred implementation of the roller-wheel 110 relies on its shape (discussed above), the weight of the lawn roller-wheelbarrow 100 as a whole, and any load carried by the tray 112 to function as a conventional lawn roller. Correspondingly, the roller-wheel 100 has a hollow cylindrical body portion that is not adapted to be filled with a fluid or any other material. The body portion of the roller-wheel 110 could be fabricated of sheet metal bent into a cylindrical shape, a molded plastic (e.g., high density polyethylene), or another suitable material and/or process known to one of ordinary skill in the art. In some implementations, not shown, the roller-wheel can be adapted to be filled with water, sand, or another material.

As shown, the roller-wheel 110 is rotatably coupled to the frame 114, specifically the roller-wheel support structure 120, by an axle 138. In some implementations, the axle 138 extends through the roller-wheel 110 and is coupled to the frame 114 by a pair of brackets 140, each end of the axle 138 being secured to the underside of a lateral frame member 134 of the roller-wheel support structure 120.

As shown best in FIGS. 1 and 8, the load carrying tray 112 is configured to carry wet and/or dry material, and may be any shape and volume suitable for doing so. Additionally, the tray 112 may be made out of any number of materials including, but in no way limited to, metal, plastic, composite materials, or any suitable combination thereof. As shown, the tray 112 may be securely coupled to the frame 114, specifically the roller-wheel support structure 120, by one or more tray braces 136. Each tray brace 136 is secured to a lateral frame member 134 of the roller-wheel support structure 120.

For the purpose of clarity, fasteners used to assemble the lawn roller-wheelbarrow 100 have been omitted from the illustrations. It should be understood through, that suitable fasteners such as screws, rivets, adhesives, and the like can be used to assemble the lawn roller-wheelbarrow 100. One of ordinary skill in the art, having the benefit of the present disclosure, would be able to select appropriate fasteners.

In operation, the lawn roller-wheelbarrow 100 is moved by lifting its handles 116, 118 to raise the leg members 128 of the stand 126 off the ground, and walking. The preferred implementation of the lawn roller-wheelbarrow 100, and any load carried thereby, easily balances due to the width of the roller-wheel 110. The lawn roller-wheel barrow 110 is unloaded (i.e., dumped), by lifting the handles 116, 118 to tip the tray 112 into a vertical position where the load slides or pours out the sloped front end of the tray 112. While in the described vertical position, the lawn roller-wheelbarrow 100 rest on the front frame member 134 of the roller-wheel support structure 120.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A lawn roller-wheelbarrow that can be used to even out a lawn surface and to transport a load, the lawn roller-wheelbarrow comprising:
a frame that includes a pair of handles;
a tray mounted on the frame that is adapted for carrying a load; and
a roller-wheel rotatably mounted to the frame;
wherein the roller-wheel has the general shape of a cylinder and a length L that is greater than its width W.

2. The lawn roller-wheelbarrow of claim 1, further comprising a stand that is secured to the frame.

3. A lawn roller-wheelbarrow that can be used to even out a lawn surface and to transport a load, the lawn roller-wheelbarrow comprising:
a frame that includes a roller-wheel support structure and pair of arm members, each arm member includes a handle on one end;
a tray mounted on the frame that is adapted for carrying a load; and
a roller-wheel rotatably mounted within an opening defined by the roller-wheel support structure of the frame;
wherein the roller-wheel has the general shape of a cylinder and a length L that is greater than its width W.

4. The lawn roller-wheelbarrow of claim 3, wherein the pair of arm members extend rearwardly from the roller-wheel support structure and underneath the tray, thereby providing support for the tray resting thereon.

5. The lawn roller-wheelbarrow of claim 3, further comprising a stand that is secured to the frame.

6. The lawn roller-wheelbarrow of claim 3, wherein the roller-wheel is rotatably mounted on an axle, each end of the axle is secured to the roller-wheel support structure.

7. The lawn roller-wheelbarrow of claim 3, further comprising one or more tray braces used to couple the tray to the frame, each tray brace is secured to the roller-wheel support structure.

8. A lawn roller-wheelbarrow that can be used to even out a lawn surface and to transport a load, the lawn roller-wheelbarrow comprising:
a frame that includes a roller-wheel support structure and pair of arm members, each arm member includes a handle on one end;
a tray mounted on the frame that is adapted for carrying a load; and
a roller-wheel rotatably mounted within a rectangle-shaped opening defined by the roller-wheel support structure of the frame;
wherein the roller-wheel has the general shape of a cylinder and a length L that is greater than its width W.

9. The lawn roller-wheelbarrow of claim 8, wherein the pair of arm members extend rearwardly from the roller-wheel support structure and underneath the tray, thereby providing support for the tray resting thereon.

10. The lawn roller-wheelbarrow of claim 8, the rectangle-shaped opening is defined by an arrangement of four frame members secured together to form the roller-wheel support structure.

11. The lawn roller-wheelbarrow of claim 10, wherein the roller-wheel is rotatably mounted on an axle, each end of the axle is secured to a lateral frame member of the roller-wheel support structure.

12. The lawn roller-wheelbarrow of claim 10, further comprising one or more tray braces used to couple the tray to the frame, each tray brace is secured to a lateral frame member of the roller-wheel support structure.

13. The lawn roller-wheelbarrow of claim 8, further comprising a stand that is secured to the frame.
